(19) United States
(12) Patent Application Publication
(10) Pub. No.: US 2026/0183171 A1
(43) Pub. Date: Jul. 2, 2026

(54) LIMB TRACTION DEVICES AND METHODS OF APPLYING TRACTION TO AN INJURED LIMB

(71) Applicant: Samuel Slishman, San Luis Obispo, CA (US)

(72) Inventor: Samuel Slishman, San Luis Obispo, CA (US)

(21) Appl. No.: 19/422,000

(22) Filed: Dec. 16, 2025

Related U.S. Application Data
(60) Provisional application No. 63/739,120, filed on Dec. 27, 2024.

(51) Int. Cl. A61H 1/02

(52) U.S. Cl. CPC A61H 1/0218

(57) ABSTRACT

Limb traction devices and methods of applying traction to an injured limb are disclosed herein. The limb traction devices include a limb anchor and a tether. The limb anchor is configured to be operatively attached to an injured limb of an individual. The tether extends from the limb anchor and is configured to receive a traction force to apply traction to the injured limb. The traction force may be applied by the individual, such as by being applied by the individual to the individual's own injured limb. The methods include operatively attaching a limb anchor of a limb traction device to an injured limb. The methods also include applying a traction force to the injured limb via a tether of the limb traction device. The tether is operatively attached to the limb anchor, and the traction force is applied by the individual.

### RELATED APPLICATION

This application claims priority to U.S. Provisional Ser. No. 63/739,120 , which was filed on Dec. 27, 2024, and the complete disclosure of which is hereby incorporated by reference.

### FIELD OF THE DISCLOSURE

The present disclosure relates generally to limb traction devices and to methods of applying traction to an injured limb.

### BACKGROUND OF THE DISCLOSURE

In certain circumstances, it may be desirable to apply traction to an injured limb, such as to realign the injured limb, facilitate recovery of the injured limb, and/or stabilize the injured limb. For some injuries, application of traction alone may be sufficient to provide significant pain relief and/or permit an injured individual to reacquire nearly full use of the injured limb. As an example, reduction of a dislocated shoulder may be accomplished via application of traction, and such reduction may decrease pain substantially and transform an acutely debilitating injury into a significantly less significant annoyance, thereby permitting the injured individual to resume normal, or nearly normal, activity. Subsequent to an injury, it may be desirable to apply traction to the injured limb as soon as possible. However, conventional devices for application of limb traction generally cannot be carried in the field and instead are utilized after the injured individual has been evacuated from a location of the injury and/or moved to a treatment facility. This time delay increases muscle contraction, making it significantly more difficult to benefit from the application of traction. Thus, there exists a need for improved limb traction devices and methods of applying traction to an injured limb, such as improved limb traction devices and/or methods that conveniently may be carried by the individual during normal activities and/or utilized at the location of the injury.

### SUMMARY OF THE DISCLOSURE

Limb traction devices and methods of applying traction to an injured limb are disclosed herein. The limb traction devices include a limb anchor and a tether. The limb anchor is configured to be operatively attached to an injured limb of an individual. The tether extends from the limb anchor and is configured to receive a traction force to apply traction to the injured limb. The traction force may be applied by the individual, thus enabling the individual to apply, and to control the application of, the traction force to the individual's own injured limb. The methods include operatively attaching a limb anchor of a limb traction device to an injured limb. The methods also include applying a traction force to the injured limb via a tether of the limb traction device. The tether is operatively attached to the limb anchor, and the traction force is applied by the individual.

### BRIEF DESCRIPTION OF THE DRAWINGS

FIG. 1 is a schematic illustration of examples of limb traction devices that may be utilized to apply a traction force to an injured limb of an individual, according to the present disclosure.

FIG. 2 is a less schematic illustration of an example of a limb traction device according to the present disclosure.

FIG. 3 is a schematic illustration of examples of a methodology for applying limb traction utilizing a limb traction device, according to the present disclosure.

FIG. 4 is a less schematic illustration of the methodology of FIG. 3.

FIG. 5 is a schematic illustration of examples of other methodologies for applying limb traction utilizing a limb traction device, according to the present disclosure.

FIG. 6 is a schematic illustration of examples of other methodologies for applying limb traction utilizing a limb traction device, according to the present disclosure.

FIG. 7 is a less schematic illustration of the methodology of FIG. 6.

FIG. 8 is a flowchart illustrating examples of methods of providing traction to an injured limb of an individual, according to the present disclosure.

### DETAILED DESCRIPTION AND BEST MODE OF THE DISCLOSURE

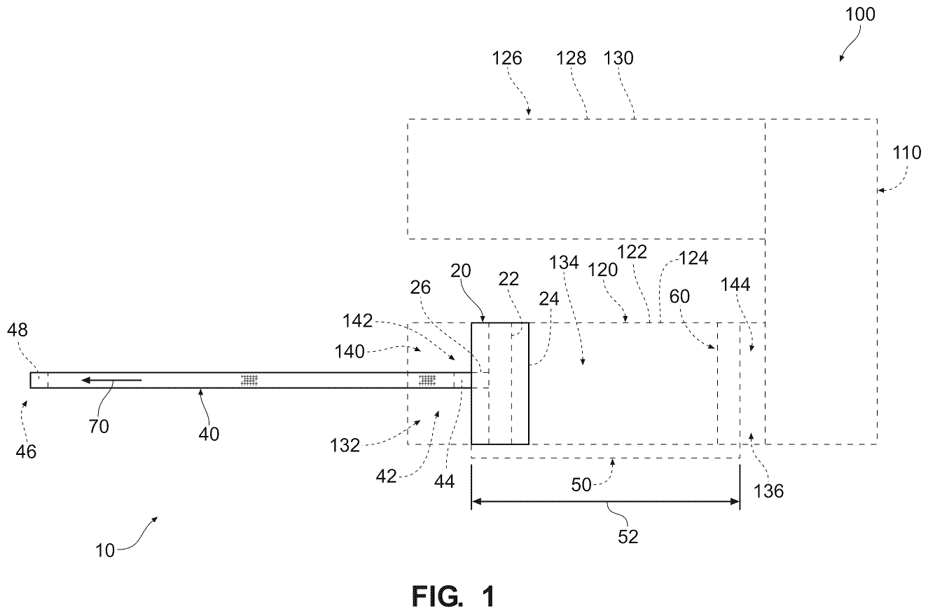

FIGS. 1-8 provide examples of limb traction devices 10 and/or methods 200, according to the present disclosure. Elements that serve a similar, or at least substantially similar, purpose are labeled with like numbers in each of FIGS. 1-8, and these elements may not be discussed in detail herein with reference to each of FIGS. 1-8. Similarly, all elements may not be labeled in each of FIGS. 1-8, but reference numerals associated therewith may be utilized herein for consistency. Elements, components, functions, and/or features that are discussed herein with reference to one or more of FIGS. 1-8 may be included in and/or utilized with any of FIGS. 1-8 without departing from the scope of the present disclosure. In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

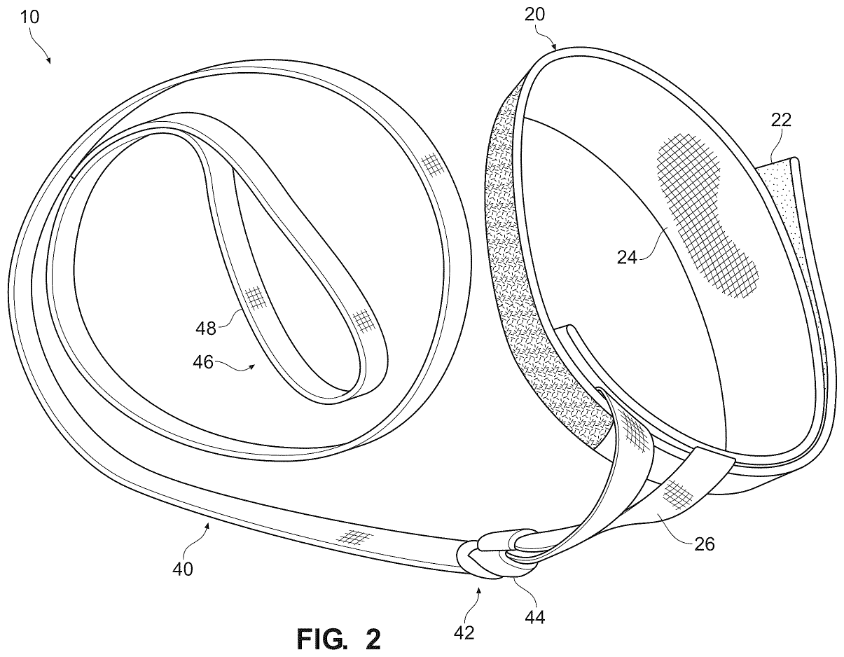

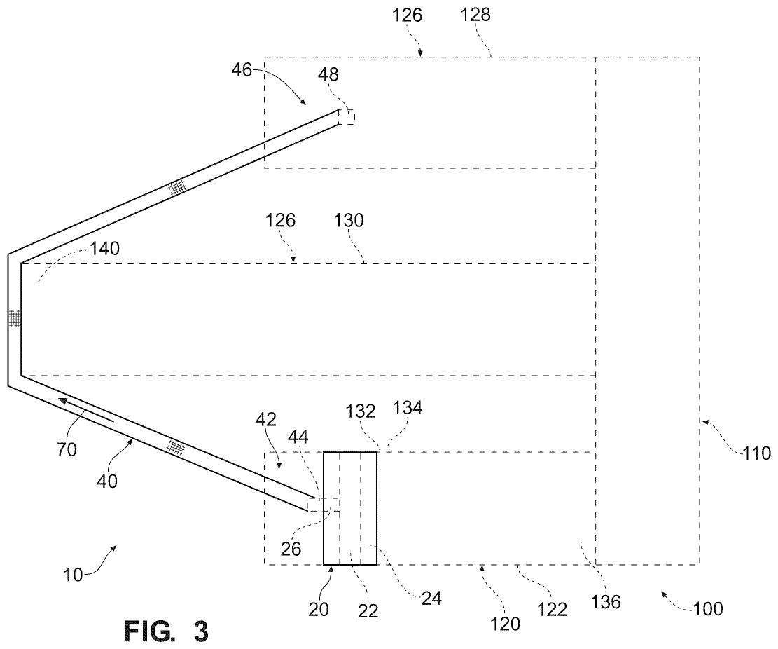

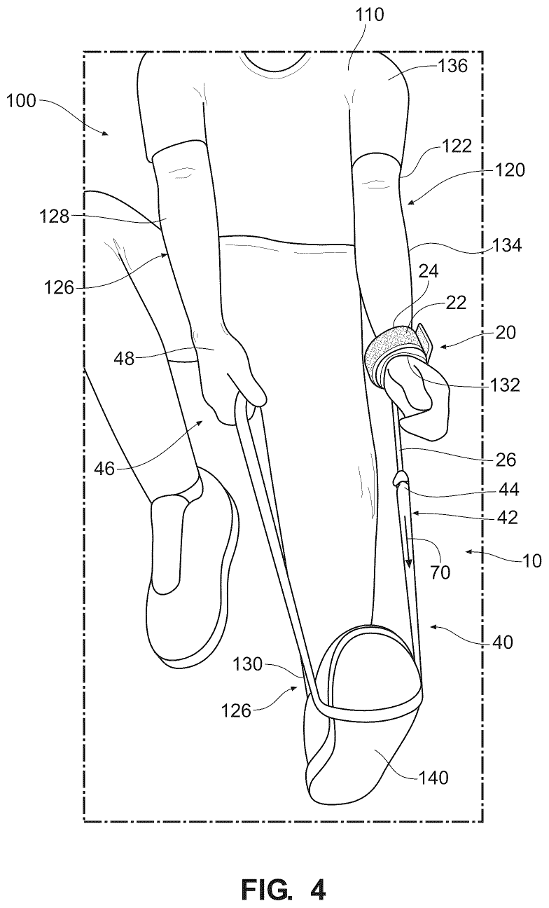

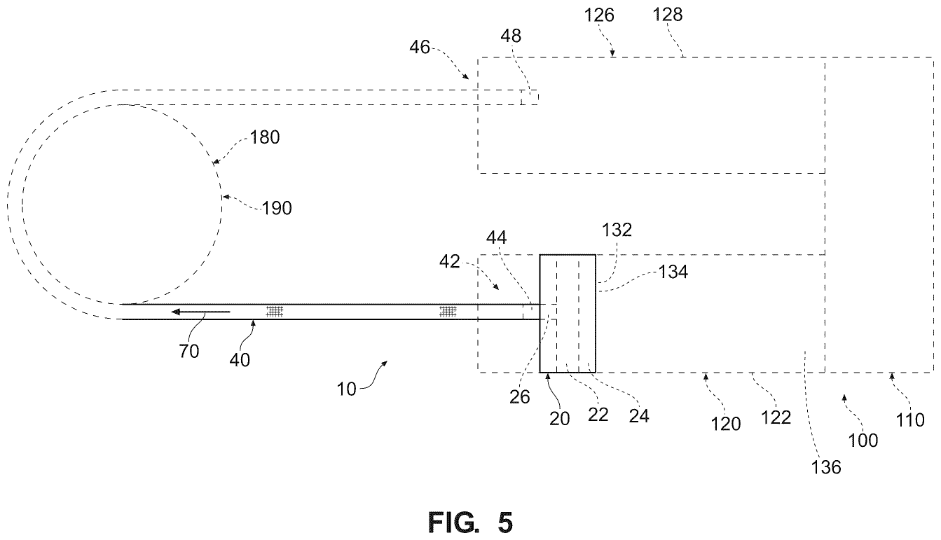

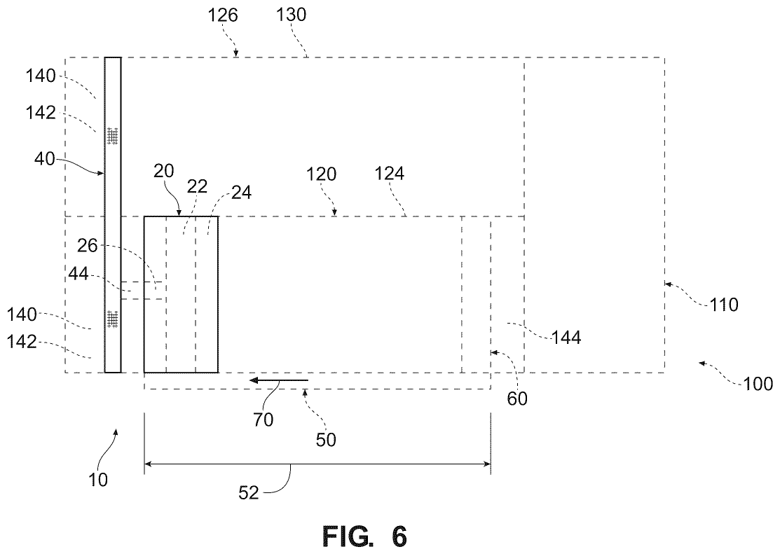

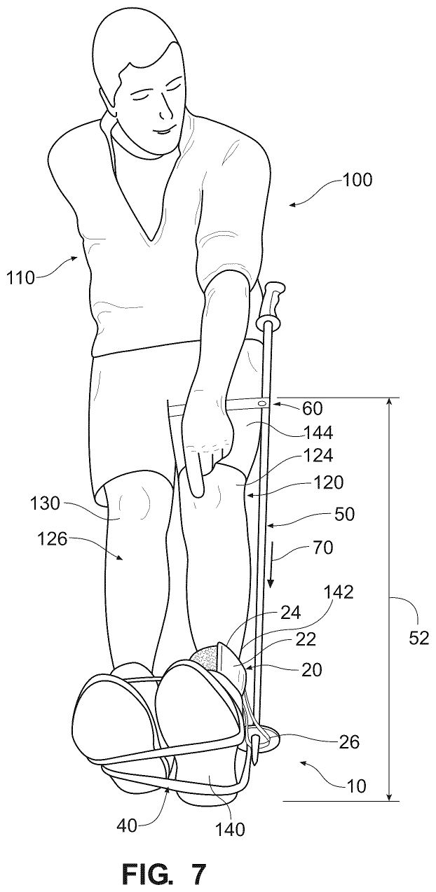

FIG. 1 is a schematic illustration of examples of limb traction devices 10 that may be utilized to apply a traction force 70 to an injured limb 120 of an individual 100, according to the present disclosure, and FIG. 2 is a less schematic illustration of an example of limb traction device 10. FIG. 3 is a schematic illustration of examples of a methodology for applying limb traction utilizing limb traction device 10, and FIG. 4 is a less schematic illustration of the methodology of FIG. 3. FIG. 5 is a schematic illustration of examples of other methodologies for applying limb traction utilizing limb traction device 10. FIG. 6 is a schematic illustration of examples of other methodologies for applying limb traction utilizing limb traction device 10, and FIG. 7 is a less schematic illustration of the methodology of FIG. 6.

As collectively illustrated by FIGS. 1-7, limb traction devices 10 include a limb anchor 20 and a tether 40. As illustrated in FIGS. 1-7, limb anchor 20 may be configured to be operatively attached to an injured limb 120 of an individual 100. As also illustrated, tether 40 may extend from limb anchor 20 and/or may be configured to receive a traction force 70 to apply traction to injured limb 120.

Limb traction device 10 may be utilized to apply traction force 70 to a variety of different injured limbs 120 in a variety of different manners. Examples of operative use of limb traction device 10 to apply traction force 70 are discussed in more detail herein with reference to methods 200. In some examples, limb traction device 10 may be configured to permit individual 100, who also may be referred to herein as an injured individual 100, to apply, to at least substantially apply, and/or to fully apply, the traction force. Additionally or alternatively, and in some examples, limb traction device 10 may be configured to permit another individual to at least partially or at least substantially apply the traction force.

As an example, and as perhaps best illustrated in FIGS. 3-5, injured limb 120 may include and/or be an injured arm 122, such as may have a dislocated shoulder 136. In such a configuration, limb traction device 10 may be configured to permit and/or facilitate reduction and/or relocation of dislocated shoulder 136 via application of traction force 70. This may be accomplished in any suitable manner. As an example, limb anchor 20 may be operatively attached to a wrist 132 or to an elbow 134 of injured arm 122, and tether 40 may extend away from injured arm 122.

As illustrated in FIGS. 3-4, tether 40 may be looped and/or extended around an uninjured limb 126, such as an uninjured leg 130 and/or a foot 140 of the uninjured leg of the individual. In addition, a free end 46 of tether 40 may be held by an uninjured limb 126, such as an uninjured arm 128 of the individual. Then, the individual may extend uninjured leg 130, may pull with uninjured arm 128, and/or may lean their torso 110 away from uninjured leg 130, thereby applying traction force 70 to injured arm 122. Such a configuration may permit individual 100 to control, or fully control, application of traction force 70, a duration of application of the traction force, and/or a magnitude of the traction force.

Alternatively, and as illustrated in FIG. 5, tether 40 may be attached to an immobile object 180 or tether 40 may be looped around and/or may be extended around the immobile object and free end 46 may be held by uninjured arm 128. Then, the individual may pull with uninjured arm 128 and/or may lean torso 110 away from immobile object 180, thereby applying traction force 70 to injured arm 122. Such a configuration also may permit individual 100 to control, or fully control, application of traction force 70, the duration of application of the traction force, and/or the magnitude of the traction force.

As another example, and as also illustrated in FIG. 5, tether 40 may be held by another individual 190. Then, individual 100 may lean torso 110 away from other individual 190, thereby applying traction force 70 to injured arm 122. Additionally or alternatively, the other individual may pull on tether 40, thereby applying traction force 70 to injured arm 122. Such a configuration may permit individual 100 to have at least some control over application of traction force 70, the duration of application of the traction force, and/or the magnitude of the traction force while also permitting the other individual to assist with application of the traction force.

In some examples, and as perhaps best illustrated in FIGS. 6-7, injured limb 120 may include and/or be an injured leg 124, such as may be broken, may have a broken bone, and/or may have a broken femur. In such a configuration, limb traction device 10 may be configured to permit and/or facilitate application of traction force 70, such as a femoral traction force 70, to injured leg 124. This may be accomplished in any suitable manner. As an example, limb anchor 20 may be operatively attached to injured leg 124, such as to an ankle 142 of the injured leg. In addition, tether 40 may be wrapped around a foot 140 and/or an ankle 142 of an uninjured leg 130, such as to provide rotational stability to injured leg 124. Then, a pole 50 may be extended between limb anchor 20 and a thigh 144 of injured leg 124 to facilitate application of traction force 70. As an example, a pole length 52 of the pole may be adjusted to apply and/or to adjust traction force 70. Examples of pole 50 include a length-adjustable pole, a ski pole, and/or a trekking pole. In some such examples, a strap 60 may be operatively attached to thigh 144. In such a configuration, pole 50 may extend between strap 60 and limb anchor 20 and/or may apply traction force 70 at least partially via strap 60.

Limb traction devices 10, according to the present disclosure, may provide a number of distinct benefits over conventional devices for application of limb traction. As an example, and as discussed, limb traction devices 10 may be utilized to apply traction force 70 in a variety of different ways, thereby providing treatment flexibility that may not readily be provided by conventional devices for application of limb traction. As another example, limb traction devices 10 may be lightweight and portable, thereby permitting an individual to carry a limb traction device 10 with them in the field and/or when performing activities where injury may occur. This may permit the individual to apply the traction force immediately after injury and/or without assistance from someone else, thereby quickly alleviating pain associated with the injury, reversing the injury, and/or avoiding muscle contraction that otherwise would make treatment less effective. As yet another example, self-application of the traction force by, or solely by, the individual, may make it easier for the individual to relax corresponding muscles, thereby making the traction force more effective at treating the injury. As another example, limb traction devices 10 may be multi-functional and/or may be utilized for purposes in addition to those that are disclosed herein, thereby providing the individual with additional incentive to carry the limb traction device with them in the field.

Limb anchor 20 may include any suitable structure that may be adapted, configured, designed, and/or constructed to be operatively attached to injured limb 120 and/or from which tether 40 may extend. Limb anchor 20 may be operatively attached to injured limb 120 in any suitable manner. As an example, limb anchor 20 may be configured to extend around injured limb 120, such as to extend around a transverse cross-section of the injured limb. In specific examples, and as discussed, the injured limb may include and/or be injured arm 122. In such a configuration, limb anchor 20 may be adapted, configured, designed, sized, and/or constructed to extend around wrist 132 and/or elbow 134 of the injured arm. In other specific examples, and as also discussed, the injured limb may include injured leg 124. In such a configuration, limb anchor 20 may be adapted, configured, designed, sized, and/or constructed to extend around foot 140 and/or ankle 142 of the injured leg.

Limb anchor 20 may include and/or be an adjustable limb anchor, such as may be configured to be operatively attached to a plurality of different limbs. The plurality of different limbs may have and/or define a plurality of different limb sizes, such as a plurality of different limb shapes, a plurality of different limb transverse cross-sectional areas, and a plurality of different limb transverse perimeters, and the adjustable limb anchor may be configured to adjust for a secure fit thereto.

This may be accomplished in any suitable manner. As an example, and as illustrated in dashed lines in FIGS. 1, 3, and 5-6 and in solid lines in FIGS. 2, 4, and 7, limb anchor 20 may include an adjustment mechanism 22. Adjustment mechanism 22 may be adapted, configured, designed, and/or constructed to permit the limb anchor to adjust to be operatively attached to the plurality of different limb sizes, the plurality of different limb shapes, the plurality of different limb transverse cross-sectional areas, and/or the plurality of different limb transverse perimeters. As an example, adjustment mechanism 22 may be configured to permit adjustment of an internal perimeter of limb anchor 20 over at least a threshold internal perimeter range, examples of which include at least 10 centimeters (cm), at least 20 cm, at least 30 cm, at least 40 cm, at most 60 cm, at most 50 cm, at most 40 cm, at most 30 cm, and/or at most 20 cm.

Adjustment mechanism 22 may include any suitable structure, examples of which include a strap, a clasp, a buckle, a ladder lock, a D-ring, a pair of D-rings, a cinch, and a clip. In specific examples, adjustment mechanism 22 may include and/or be a hook-and-loop fastener adjustment mechanism. In some examples, adjustment mechanism 22 may include and/or be a discretely adjustable adjustment mechanism, such as may be configured to be adjusted among a plurality of different, and discretely defined, sizes. In some examples, adjustment mechanism 22 may include and/or be a continuously adjustable adjustment mechanism, such as may be configured to be continuously and/or infinitely adjusted between a minimum size and a maximum size.

As illustrated in dashed lines in FIGS. 1, 3, and 5-6 and in solid lines in FIGS. 2, 4, and 7, limb anchor 20 may include a liner material 24. Liner material 24 may be configured to contact injured limb 120 and/or to decrease a potential for discomfort in, or to, the injured limb, such as may be caused by contact with limb anchor 20 when tether 40 receives traction force 70. Stated differently, liner material 24 may be configured to cushion and/or distribute application of traction force 70 to a region of injured limb 120 to which limb anchor 20 is attached, thereby decreasing discomfort in the injured limb, especially when the traction force is applied for an extended period of time. Liner material 24 additionally or alternatively may be referred to as a liner 24. Liner material 24 may be configured to extend around at least a substantial portion of the inner, or limb-contacting, surface of the individual's injured limb, such as by extending along at least a substantial portion of the inner surface of limb anchor 20.

Liner material 24 may include and/or be any suitable material that decreases the potential for discomfort in the injured limb. Examples of liner material 24 include a resilient liner material, a flexible liner material, an elastic liner material, a polychloroprene, and/or Neoprene®. As discussed, limb anchor 20 also may include adjustment mechanism 22, and adjustment mechanism 22 may be an inelastic adjustment mechanism and/or may be formed from an inelastic material. In such a configuration, adjustment mechanism 22 may extend around an outer perimeter of liner material 24 such that the liner material maintains a spaced-apart relationship between the adjustment mechanism and the injured limb when the limb anchor is operatively attached to the injured limb. Such a configuration may permit liner material 24 to cushion the injured limb from adjustment mechanism 22 and/or may decrease a potential for discomfort in the injured limb that may be caused by contact, or direct contact, with the adjustment mechanism.

Tether 40 may include any suitable structure that may extend from limb anchor 20, that may be configured to receive traction force 70, and/or that may be configured to apply traction force 70 to injured limb 120, such as via limb anchor 20. Examples of tether 40 include a rope, a strap, and a cord. Tether 40 may include and/or be a flexible tether, a pliable tether, and/or a supple tether. Such a configuration may permit and/or facilitate storage and/or transport of limb traction devices 10 and/or may permit tether 40 to extend and/or be looped around other structures, as is discussed in more detail herein. In some examples, tether 40 may include and/or be an inelastic and/or a non-stretchy tether 40. Such a configuration may permit and/or facilitate more direct application of traction force 70 and/or application of a relatively larger magnitude traction force 70 via tether 40. Alternatively, and in some examples, tether 40 may include and/or be an elastic tether and/or a resilient tether. Such a configuration may permit tether 40 to cushion application of traction force 70, may increase immobilization when tether 40 is utilized for femoral traction as is discussed herein with reference to FIGS. 6-7, and/or may permit tether 40 also to be utilized as a tourniquet.

As perhaps best illustrated in FIGS. 1-5, tether 40 may include and/or be an elongate tether, which may extend between an anchor-attached end 42 and free end 46. In some examples, free end 46 may include and/or define a handle 48, which may be configured to be gripped and/or held by a free hand of the individual, such as to apply traction force 70 and/or to facilitate application of the traction force. Examples of handle 48 include a grip, a loop, and a ring.

Limb anchor 20 and tether 40 may be operatively attached to one another and/or may be configured to remain permanently attached to one another. Stated differently, limb anchor 20 and tether 40 may not be configured to be detached from one another without damage to and/or destruction of the limb anchor and/or the tether.

Alternatively, limb anchor 20 and tether 40 may be configured to be selectively separated from one another and thereafter selectively recoupled to each other. Stated differently, limb anchor 20 and tether 40 may be configured for separation from one another without damage to and/or destruction of the limb anchor and/or the tether. Such a configuration may permit and/or facilitate independent utilization of the limb anchor and the tether and/or may increase the individual's options for operative use and/or storage of the limb anchor and the tether.

This may be accomplished in any suitable manner. As an example, anchor-attached end 42 may define a tether attachment structure 44, which may be configured to be operatively attached to an anchor attachment structure 26 of limb anchor 20. An example of tether attachment structure 44 includes a tether attachment loop, and an example of anchor attachment structure 26 includes an anchor attachment loop. In such a configuration, the anchor attachment structure and the tether attachment structure may be configured to be operatively attached to one another via a girth hitch. Other configurations also are within the scope of the present disclosure, including any suitable fastener, clasp, and/or buckle that may be utilized to selectively and operatively attach and/or detach limb anchor 20 and tether 40.

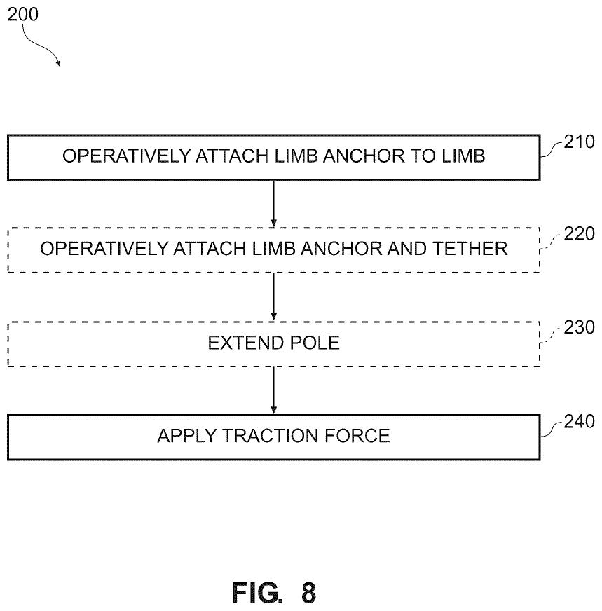

FIG. 8 is a flowchart illustrating examples of methods 200 of providing traction to an injured limb of an individual, according to the present disclosure. Methods 200 include operatively attaching a limb anchor to a limb at 210, and methods 200 may include operatively attaching the limb anchor and a tether at 220. Methods 200 also may include extending a pole at 230, and methods 200 include applying a traction force at 240.

Operatively attaching the limb anchor to the limb at 210 may include operatively attaching the limb anchor to the injured limb. The limb anchor may form a portion of a limb traction device that also may include a tether, which may be operatively attached to the limb anchor. Examples of the limb traction device and/or components thereof are disclosed herein with reference to limb traction device 10.

The operatively attaching at 210 may include operatively attaching the limb anchor such that the tether extends away from a torso of the individual as measured along a length of the injured limb. This is illustrated in FIGS. 1 and 3-5, with limb anchor 20 being operatively attached to injured limb 120 of individual 100 and tether 40 extending away from torso 110 of the individual. The injured limb may include and/or be an injured arm and/or an injured shoulder of the injured arm. In such a configuration, the operatively attaching at 210 may include operatively attaching the limb anchor to a wrist of the injured arm and/or to an elbow of the injured arm. This is illustrated in FIGS. 1 and 3-5, with limb anchor 20 being operatively attached to wrist 132 of injured arm 122. In some examples, the injured limb may include and/or be an injured leg. In such a configuration, the operatively attaching at 210 may include operatively attaching the limb anchor to an ankle of the injured leg. This is illustrated in FIGS. 6-7, with limb anchor 20 being operatively attached to ankle 142 of injured leg 124.

The operatively attaching at 210 may be accomplished in any suitable manner. As an example, the operatively attaching at 210 may include surrounding the injured limb with the limb anchor. As another example, the operatively attaching at 210 may include adjusting a size of the limb anchor to fit the injured limb, such as via utilizing an adjustment mechanism of the limb anchor. In some examples, the operatively attaching at 210 may include positioning a liner material of the limb anchor between the adjustment mechanism and the injured limb, such as to maintain a spaced-apart relationship between the adjustment mechanism and the injured limb. In some such examples, the operatively attaching at 210 also may include cushioning the injured limb with the liner material during the applying the traction force, such as to avoid and/or decrease discomfort within a region of the injured limb to which the limb anchor is attached due to and/or during application of the traction force.

In some examples, limb anchor 20 may include an anchor attachment structure, and the tether may include a tether attachment structure. The anchor attachment structure and the tether attachment structure may be configured to be operatively attached to and/or detached from one another. In such a configuration, and during the operatively attaching at 210, the tether may be detached from the limb anchor, and/or the operatively attaching at 210 may include operatively attaching the limb anchor such that the anchor attachment structure extends away from the torso of the individual, such as may be measured along the length of the injured limb. When the tether is detached from the limb anchor during the attaching at 210, the operatively attaching the limb anchor and the tether at 220 may be performed to operatively attach the limb anchor and the tether to one another, such as via operatively attaching the anchor attachment structure and the tether attachment structure to one another.

In some examples, and as discussed in more detail herein, a pole may be utilized to at least partially apply the traction force. In such examples, extending the pole at 230 may include extending the pole to increase, to adjust, and/or to apply the traction force.

Applying the traction force at 240 may include applying the traction force to the injured limb. This may include applying the traction force via the limb anchor and/or via the tether. In some examples, the applying at 240 may include applying the traction force by, at least substantially by, or solely by, the individual. Such a configuration may permit the individual to control, or fully control, application of the traction force, a duration of application of the traction force, and/or a magnitude of the traction force. In some examples, the applying at 240 may include at least partially or at least substantially applying the traction force by another individual. Such a configuration may permit the other individual to assist with application of the traction force, such as in circumstances wherein the injured individual is unable, or unwilling, to apply the traction force.

In a specific example, the injured limb includes the injured shoulder of the injured arm of the individual. In such examples, and as discussed, the operatively attaching at 210 may include operatively attaching the limb anchor to the wrist of the injured arm and/or to the elbow of the injured arm. Then, the applying at 240 may include applying the traction force in a number of different ways.

As an example, the applying at 240 may include looping the tether around a leg of the individual or a foot of the individual and holding the tether with an uninjured arm of the individual. Then, the traction force may be applied by extending the leg, by pulling on the tether with the uninjured arm, and/or by leaning the individual's torso backward and/or away from the leg.

As another example, the applying at 240 may include attaching the tether to an immobile object and/or looping the tether around the immobile object. Then, the traction force may be applied by pulling against the immobile object, such as by pulling on a free end of the tether with the uninjured arm and/or leaning the individual's torso backward and/or away from the immobile object.

As yet another example, the applying at 240 may include utilizing another individual to pull on the tether and apply the traction force. This may include holding the free end of the tether by the other individual, initiating application of the traction force by the other individual, and/or initiating application of the traction force by the injured individual, such as to permit and/or facilitate at least partial control of the traction force by the injured individual.

In another specific example, the injured limb includes an injured leg of the individual. In such examples, the operatively attaching at 210 may include operatively attaching the limb anchor to an ankle of the injured leg. In some such examples, the operatively attaching at 210 also may include wrapping the tether around a foot and/or ankle of the injured leg and also around a foot and/or ankle of an uninjured leg of the individual, such as to provide rotational stability to the injured leg. In such a configuration, the extending at 230 may be utilized to extend the pole between the limb anchor and a thigh of the individual. This may include extending the pole to apply, or to facilitate application of, femoral traction to the injured leg by the individual and/or to initiate the applying at 240. Also in such a configuration, the applying at 240 may include adjusting a pole length of the pole to adjust a magnitude of the traction force. In some such examples, the operatively attaching at 210 also may include operatively attaching a strap to the thigh of the injured leg. In such a configuration, the applying at 240 may include applying the traction force at least partially via the strap and/or between the strap and the limb anchor.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of limb traction devices and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.
A1. A limb traction device, comprising:
   a limb anchor configured to be operatively attached to an injured limb of an individual; and
   a tether that extends from the limb anchor and is configured to receive a traction force to apply traction to the injured limb.
A2. The limb traction device of paragraph A1, wherein the limb anchor is configured to extend around at least one of the injured limb and a transverse cross-section of the injured limb.
A3. The limb traction device of any of paragraphs A1-A2, wherein the injured limb includes, or is, an injured arm, and further wherein the limb anchor is configured to extend around at least one of a wrist of the injured arm and an elbow of the injured arm.
A4. The limb traction device of any of paragraphs A1-A3, wherein the limb anchor is an adjustable limb anchor configured to be operatively attached to a plurality of different limbs of at least one of a plurality of different limb sizes, a plurality of different limb shapes, a plurality of different limb transverse cross-sectional areas, and a plurality of different limb transverse perimeters.
A5. The limb traction device of any of paragraphs A1-A4, wherein the limb anchor includes an adjustment mechanism configured to permit the limb anchor to adjust to be operatively attached to at least one of a/the plurality of different limb sizes, a/the plurality of different limb shapes, a/the plurality of different limb transverse cross-sectional areas, and a/the plurality of different limb transverse perimeters.
A6. The limb traction device of paragraph A5, wherein the adjustment mechanism includes at least one of a strap, a clasp, a buckle, a ladder lock, a D-ring, a pair of D-rings, a cinch, and a clip.
A7. The limb traction device of any of paragraphs A5-A6, wherein the adjustment mechanism includes a discretely adjustable adjustment mechanism.
A8. The limb traction device of any of paragraphs A5-A7, wherein the adjustment mechanism includes a continuously adjustable adjustment mechanism.
A9. The limb traction device of any of paragraphs A5-A8, wherein the adjustment mechanism includes a hook-and-loop fastener adjustment mechanism.
A10. The limb traction device of any of paragraphs A1-A9, wherein the limb anchor includes a liner material configured to contact the injured limb and to decrease a potential for discomfort in the injured limb caused by contact with the limb anchor when the tether receives the traction force.
A11. The limb traction device of paragraph A10, wherein the liner material includes at least one of a resilient liner material, a flexible liner material, an elastic liner material, a polychloroprene, and Neoprene®.
A12. The limb traction device of any of paragraphs A10-A11, wherein the limb anchor includes an/the adjustment mechanism, wherein the adjustment mechanism is an inelastic adjustment mechanism, and further wherein the adjustment mechanism extends around an outer perimeter of the liner material such that the liner material maintains a spaced-apart relationship between the adjustment mechanism and the injured limb when the limb anchor is operatively attached to the injured limb.
A13. The limb traction device of any of paragraphs A1-A12, wherein the tether is an elongate tether that extends between an anchor-attached end and a free end.
A14. The limb traction device of paragraph A13, wherein the anchor-attached end defines a tether attachment structure configured to be operatively attached to an anchor attachment structure of the limb anchor.
A15. The limb traction device of any of paragraphs A13-A14, wherein the free end defines a handle configured to be gripped by a free hand of the individual to apply the traction force.
A16. The limb traction device of paragraph A15, wherein the handle includes at least one of a grip, a loop, and a ring.
A17. The limb traction device of any of paragraphs A1-A16, wherein the tether includes, or is, at least one of an elastic tether and a resilient tether.
A18. The limb traction device of any of paragraphs A1-A17, wherein the tether includes, or is, an inelastic tether.
A19. The limb traction device of any of paragraphs A1-A18, wherein the tether includes, or is, at least one of a flexible tether, a pliable tether, and a supple tether.
A20. The limb traction device of any of paragraphs A1-A19, wherein the limb anchor and the tether are operatively attached to one another, optionally wherein the limb anchor and the tether are configured to remain permanently attached to one another, and further optionally wherein the limb anchor and the tether are not configured to be detached from one another without damage or destruction of at least one of the limb anchor and the tether.
A21. The limb traction device of any of paragraphs A1-A20, wherein the limb anchor and the tether are configured to be separated from one another, optionally without damage or destruction of the limb anchor or the tether, to permit independent utilization of the limb anchor and the tether.
A22. The limb traction device of any of paragraphs A1-A21, wherein the limb anchor includes an/the anchor attachment structure, and further wherein the tether includes a/the tether attachment structure configured to operatively attach to the anchor attachment structure.
A23. The limb traction device of paragraph A22, wherein the anchor attachment structure includes an anchor attachment loop, and further wherein the tether attachment structure includes a tether attachment loop.
A24. The limb traction device of any of paragraphs A22-A23, wherein the anchor attachment structure and the tether attachment structure are configured to be operatively attached to one another via a girth hitch.
A25. The limb traction device of any of paragraphs A1-A24, wherein the limb traction device is configured to permit the individual to apply the traction force, and optionally to permit the individual to fully apply the traction force.
A26. The limb traction device of any of claims A1-A25, wherein the tether is configured to be looped around at least one of a leg and a foot of the individual and held by an uninjured arm of the individual to permit the individual to self-apply the traction force by at least one of:
   (i) extending the leg; and
   (ii) pulling with the uninjured arm.
A27. The limb traction device of any of paragraphs A1-A26, wherein the tether is configured to be operatively attached to an immobile object to permit the individual to self-apply the traction force by pulling against the immobile object via the tether.
A28. The limb traction device of any of paragraphs A1-A27, wherein the limb traction device is configured to permit another individual to at least partially apply the traction force.
A29. The limb traction device of any of paragraphs A1-A28, wherein the injured limb includes a dislocated shoulder, and further wherein the limb traction device is configured to facilitate relocation of the dislocated shoulder via application of the traction force.
A30. The limb traction device of any of paragraphs A1-A29, wherein the injured limb includes an injured leg, and further wherein the limb traction device is configured to facilitate femoral traction of the injured leg.
A31. The limb traction device of paragraph A30, in combination with a pole configured to extend between the limb anchor and a thigh of the injured leg, wherein the limb anchor is configured to be operatively attached to an ankle of the injured leg, and wherein the pole is configured to extend between the limb anchor and the thigh of the injured leg to facilitate application of the femoral traction by the individual.
A32. The limb traction device of paragraph A31, wherein the limb traction device further includes the pole.
A33. The limb traction device of any of paragraphs A31-A32, wherein the pole includes at least one of a length-adjustable pole, a ski pole, and a trekking pole.
A34. The limb traction device of paragraph A33, wherein adjustment of a pole length of the pole is utilized to adjust the traction force.
A35. The limb traction device of any of paragraphs A32-A33, wherein the limb traction device further includes a strap configured to be operatively attached to the thigh of the injured leg, and further wherein the pole is configured to extend between the limb anchor and the strap.
A36. The limb traction device of any of paragraphs A31-A35, wherein the tether is configured to be wrapped around a foot of the injured leg and also around a foot of an uninjured leg of the individual to provide rotational stability to the injured leg.
B1. A method of providing traction to an injured limb of an individual, the method comprising:
   operatively attaching a limb anchor of a limb traction device to the injured limb; and
   applying a traction force to the injured limb via at least one of the limb anchor and a tether of the limb traction device that is operatively attached to the limb anchor.
B2. The method of paragraph B1, wherein the operatively attaching the limb anchor includes operatively attaching the limb anchor such that the tether extends away from a torso of the individual as measured along a length of the injured limb.
B3. The method of any of paragraphs B1-B2, wherein the limb anchor includes an anchor attachment structure, wherein the tether includes a tether attachment structure configured to be operatively attached to the anchor attachment structure, and further wherein the operatively attaching the limb anchor includes operatively attaching the limb anchor such that the anchor attachment structure extends away from a/the torso of the individual as measured along a/the length of the injured limb.
B4. The method of paragraph B2, wherein the method further includes operatively attaching the anchor attachment structure and the tether attachment structure to one another.
B5. The method of any of paragraphs B1-B4, wherein the injured limb includes, or is, at least one of an injured arm and a shoulder of the injured arm, and further wherein the operatively attaching the limb anchor includes operatively attaching the limb anchor to at least one of a wrist of the injured arm and an elbow of the injured arm.
B6. The method of any of paragraphs B1-B5, wherein the injured limb includes, or is, an injured leg, and further wherein the operatively attaching the limb anchor includes operatively attaching the limb anchor to an ankle of the injured leg.
B7. The method of paragraph B6, wherein the operatively attaching further includes wrapping the tether around a foot of the injured leg and also around a foot of an uninjured leg of the individual to provide rotational stability to the injured leg.
B8. The method of paragraph B7, wherein the method further includes extending a pole between the limb anchor and a thigh of the injured leg to facilitate application of femoral traction to the injured leg by the individual.
B9. The method of paragraph B8, wherein the applying the traction force includes adjusting a pole length of the pole to adjust a magnitude of the traction force.
B10. The method of any of paragraphs B8-B9, wherein the operatively attaching further includes operatively attaching a strap to the thigh of the injured leg, and further wherein the applying the traction force includes applying the traction force at least partially via the strap.
B11. The method of any of paragraphs B1-B10, wherein the operatively attaching the limb anchor includes surrounding the injured limb with the limb anchor.
B12. The method of any of paragraphs B1-B11, wherein the operatively attaching the limb anchor includes adjusting a size of the limb anchor to fit the injured limb utilizing an adjustment mechanism of the limb anchor.
B13. The method of paragraph B12, wherein the operatively attaching the limb anchor includes positioning a liner material of the limb anchor between the adjustment mechanism and the injured limb to maintain a spaced-apart relationship between the adjustment mechanism and the injured limb.
B14. The method of paragraph B13, wherein the operatively attaching includes cushioning the injured limb with the liner material during the applying the traction force.
B15. The method of any of paragraphs B1-B14, wherein the applying the traction force includes applying the traction force solely by the individual.
B16. The method of any of paragraphs B1-B14, wherein the applying the traction force includes applying the traction force by another individual.
B17. The method of any of paragraphs B1-B16, wherein the injured limb includes a/the shoulder of an/the injured arm of the individual, wherein the operatively attaching the limb anchor includes operatively attaching the limb anchor to at least one of a/the wrist of the injured arm and an/the elbow of the injured arm.
B18. The method of paragraph B17, wherein the applying the traction force includes looping the tether around at least one of a leg of the individual and a foot of the individual, holding the tether with an uninjured arm of the individual, and extending the leg to apply the traction force.
B19. The method of any of paragraphs B17-B18, wherein the applying the traction force includes looping the tether around at least one of a/the leg of the individual and a/the foot of the individual, holding the tether with an/the uninjured arm of the individual, and pulling with the uninjured arm to apply the traction force.
B20. The method of paragraph B17, wherein the applying the traction force includes attaching the tether to an immobile object and pulling against the immobile object to apply the traction force.
B21. The method of paragraph B17, wherein the applying the traction force includes utilizing another individual to pull on the tether to apply the traction force.
B22. The method of any of paragraphs B1-B21, wherein the limb traction device includes any suitable structure, function, and/or feature of any of the limb traction devices of any of paragraphs A1-A36.

### INDUSTRIAL APPLICABILITY

The limb traction devices and methods of applying traction to an injured limb disclosed herein are applicable to the outdoor sports, medical, and limb traction industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of providing traction to an injured limb of an individual, the method comprising:
operatively attaching a limb anchor of a limb traction device to the injured limb; and
applying a traction force to the injured limb via a tether of the limb traction device that is operatively attached to the limb anchor, wherein the applying the traction force includes applying the traction force by the individual.

2. The method of claim 1, wherein the applying the traction force includes applying the traction force solely by the individual.

3. The method of claim 1, wherein the limb anchor includes an anchor attachment structure, wherein the tether includes a tether attachment structure configured to be operatively attached to the anchor attachment structure, and further wherein the operatively attaching the limb anchor includes operatively attaching the limb anchor such that the anchor attachment structure extends away from a torso of the individual as measured along a length of the limb.

4. The method of claim 3, wherein the method further includes operatively attaching the anchor attachment structure and the tether attachment structure to one another.

5. The method of claim 1, wherein the injured limb includes a shoulder of an injured arm of the individual, wherein the operatively attaching the limb anchor includes operatively attaching the limb anchor to at least one of a wrist of the injured arm and an elbow of the injured arm.

6. The method of claim 5, wherein the applying the traction force includes looping the tether around at least one of a leg and a foot of the individual, holding the tether with an uninjured arm of the individual, and extending the leg to apply the traction force.

7. The method of claim 5, wherein the applying the traction force includes looping the tether around at least one of a leg of the individual and a foot of the individual, holding the tether with an uninjured arm of the individual, and pulling with the uninjured arm to apply the traction force.

8. The method of claim 5, wherein the applying the traction force includes attaching the tether to an immobile object and pulling against the immobile object to apply the traction force.

9. The method of claim 1, wherein the injured limb includes at least one of an injured arm and a shoulder of the injured arm, and further wherein the operatively attaching the limb anchor includes operatively attaching the limb anchor to at least one of a wrist of the injured arm and an elbow of the injured arm.

10. The method of claim 1, wherein the injured limb includes an injured leg, and further wherein the operatively attaching the limb anchor includes operatively attaching the limb anchor to an ankle of the injured leg.

11. The method of claim 10, wherein the operatively attaching further includes wrapping the tether around a foot of the injured leg and also around a foot of an uninjured leg of the individual to provide rotational stability to the injured leg.

12. The method of claim 1, wherein the method further includes extending a pole between the limb anchor and a thigh of the injured leg to facilitate application of femoral traction by the individual.

13. The method of claim 12, wherein the applying the traction force includes adjusting a pole length of the pole to adjust a magnitude of the traction force.

14. The method of claim 12, wherein the operatively attaching further includes operatively attaching a strap to the thigh of the injured leg, and further wherein the applying the traction force includes applying the traction force at least partially via the strap.

15. The method of claim 1, wherein the operatively attaching the limb anchor includes surrounding the injured limb with the limb anchor.

16. The method of claim 1, wherein the operatively attaching the limb anchor includes adjusting a size of the limb anchor to fit the injured limb utilizing an adjustment mechanism of the limb anchor.

17. The method of claim 1, wherein the operatively attaching the limb anchor includes positioning a liner material of the limb anchor between the adjustment mechanism and the injured limb to maintain a spaced-apart relationship between the adjustment mechanism and the injured limb.

18. The method of claim 1, wherein the operatively attaching includes cushioning the injured limb with the liner material during the applying the traction force.

19. A limb traction device, comprising:
a limb anchor configured to be operatively attached to an injured limb of an individual; and
a tether that extends from the limb anchor and is configured to receive a traction force, which is applied by the individual, to apply traction to the injured limb.

20. The limb traction device of claim 19, wherein the limb traction device is configured to permit the individual to fully apply the traction force.
